(19) United States
(12) Patent Application Publication
(10) Pub. No.: US 2026/0362375 A1
(43) Pub. Date: Nov. 12, 2026

(54) WIRELESS STATION LOCATION IDENTIFICATION

(71) Applicant: Charter Communications Operating, LLC, St. Louis, MO (US)

(72) Inventors: Shawn Tyler Burkett, Denver, CO (US); Robert Eugene Resch, Wellington, CO (US)

(21) Appl. No.: 19/204,701

(22) Filed: May 12, 2025

(51) Int. Cl. H04W 64/00

(52) U.S. Cl. CPC H04W 64/00

(57) ABSTRACT

A first plurality of mobile device locations is identified, wherein each mobile device location identifies a location of a corresponding mobile device of a plurality of mobile devices while the mobile device was purportedly connected to a wireless station. Based at least in part on a predetermined broadcast range that corresponds to the wireless station, a size of a circle is determined. A determined location of a circular area having the size of the circle that encompasses a greatest quantity of mobile device location of the first plurality of mobile device locations is determined. A location of the wireless station within the circular area is determined. An action is performed based on the location of the wireless station.

### BACKGROUND

A large Internet service provider may install thousands of wireless stations, such as Wi-Fi® access points, throughout a large geographic area, such as the United States, to allow its customers to conveniently obtain Wi-Fi access at locations other than the customers' residences. It would be useful for such providers to know the locations of the wireless stations, however, the recorded locations of the wireless stations may differ from the actual locations due to technician error, entities other than the service provider moving the wireless stations without informing the service provider, database corruption, or the like.

### SUMMARY

The examples disclosed herein implement wireless station location identification.

In one implementation, a method is provided. The method includes identifying, by a computing device, a first plurality of mobile device locations, wherein each mobile device location identifies a location of a corresponding mobile device of a plurality of mobile devices while the mobile device was purportedly connected to a wireless station. The method further includes determining, by the computing device, based at least in part on a predetermined broadcast range that corresponds to the wireless station, a size of a circle. The method further includes identifying, by the computing device, a determined location of a circular area having the size of the circle that encompasses a greatest quantity of mobile device location of the first plurality of mobile device locations. The method further includes determining, by the computing device, a location of the wireless station within the circular area. The method further includes based on the location of the wireless station, performing, by the computing device, an action.

In another implementation, a computing device is provided. The computing device includes a memory and a processor device coupled to the memory operable to identify a first plurality of mobile device locations, wherein each mobile device location identifies a location of a corresponding mobile device of a plurality of mobile devices while the mobile device was purportedly connected to a wireless station. The processor device is further operable to determine, based at least in part on a predetermined broadcast range that corresponds to the wireless station, a size of a circle. The processor device is further operable to identify a determined location of a circular area having the size of the circle that encompasses a greatest quantity of mobile device location of the first plurality of mobile device locations. The processor device is further operable to determine a location of the wireless station within the circular area, and, based on the location of the wireless station, perform an action.

In another implementation, a non-transitory computer-readable storage medium is provided. The non-transitory computer-readable storage medium includes executable instructions operable to cause a processor device to identify a first plurality of mobile device locations, wherein each mobile device location identifies a location of a corresponding mobile device of a plurality of mobile devices while the mobile device was purportedly connected to a wireless station. The executable instructions are further operable to cause the processor device to determine, based at least in part on a predetermined broadcast range that corresponds to the wireless station, a size of a circle. The executable instructions are further operable to cause the processor device to identify a determined location of a circular area having the size of the circle that encompasses a greatest quantity of mobile device location of the first plurality of mobile device locations. The executable instructions are further operable to cause the processor device to determine a location of the wireless station within the circular area, and based on the location of the wireless station, perform an action.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which wireless station location identification can be practiced according to one implementation;

FIG. 2 is a block diagram of the environment illustrated in FIG. 1 in conjunction with a diagram for illustrating wireless station location identification according to one implementation;

FIG. 3 is a block diagram of the environment illustrated in FIG. 1 in conjunction with a diagram for illustrating the identification of a determined location of a circular area that encompasses a greatest quantity of mobile device locations according to one implementation;

FIG. 4 is a flowchart of a method for wireless station location identification can according to one implementation;

FIGS. 5A and 5B are diagrams that will be used to illustrate a mechanism for identifying a determined location of a circular area having the size of the circle that encompasses a greatest quantity of the plurality of mobile device locations according to one implementation;

FIGS. 6A-6F are diagrams that visually conceptualize the results of processing discussed with regard to FIGS. 5A-5B via a circular area rotating about a particular mobile device location E with respect to three mobile device locations A, B, and C; and

FIG. 7 is a block diagram of a computing system capable of implementing wireless station location identification according to one implementation.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A large Internet service provider may install thousands of wireless stations, such as Wi-Fi® access points, throughout a large geographic area, such as the United States, to allow its customers to conveniently obtain Wi-Fi access at locations other than the customers' residences. It would be useful for such providers to know the locations of the wireless stations, however, the recorded locations of the wireless stations may differ from the actual locations due to a technician entering the wrong location during installation, an entity other than the service provider moving the wireless station without informing the service provider, database corruption, or the like. In addition to being desirable, in some instances it may even be necessary to know the locations of the wireless stations to comply with FCC rules for example.

The examples disclosed herein implement wireless station location identification. In particular, the examples, based on reported locations of mobile devices that are purportedly connected to a wireless station, analyze circular transmission areas on the Earth to determine the most likely location of the wireless station. The examples need not obtain radio frequency information from the mobile devices or information from the wireless station.

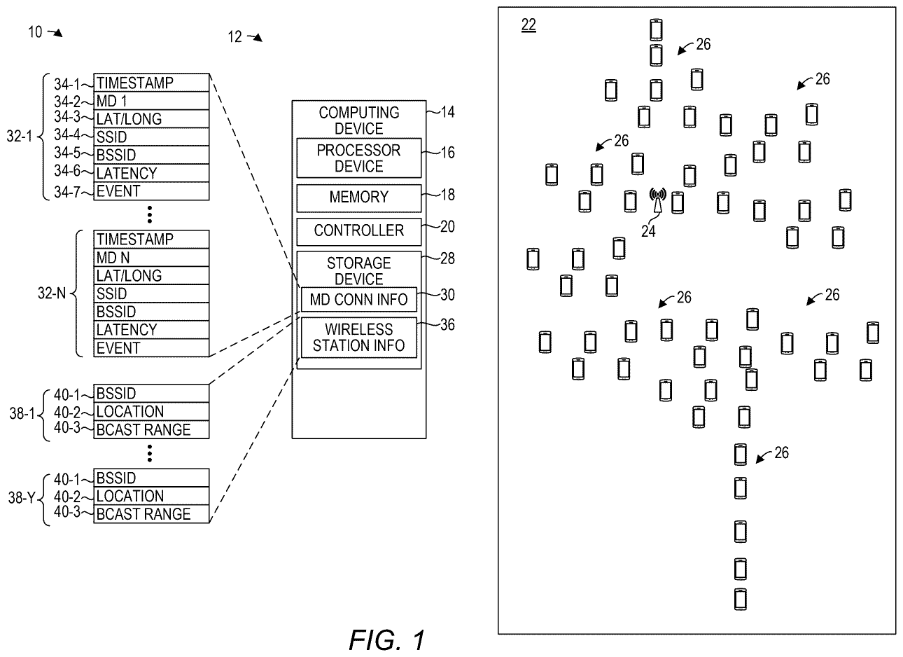

FIG. 1 is a block diagram of an environment 10 in which wireless station location identification can be practiced according to one implementation. The environment 10 includes a computing system 12 that includes one or more computing devices 14. The computing device 14 includes a processor device 16 and a memory 18. A controller 20 executes on the computing device 14 and implements certain functionality as will be described herein. It is noted that, because the controller 20 is a component of the computing system 12, functionality implemented by the controller 20 may be attributed to the computing system 12 generally. Moreover, in examples where the controller 20 comprises software instructions that program the processor device 16 to carry out functionality discussed herein, functionality implemented by the controller 20 may be attributed herein to the processor device 16.

A geographic area 22 includes a wireless station such as a wireless access point (AP) 24. In this example the AP 24 utilizes a wireless protocol, such as, by way of non-limiting example, a wireless local area network (WLAN) protocol compliant with IEEE 802.11, sometimes referred to as Wi-Fi. The term “wireless station” as used herein refers to a wireless transceiver device that operates as an aggregation point for a plurality of wireless devices and facilitates communications between such wireless devices and other devices that are connected to the wireless station. Examples of wireless stations include, by way of non-limiting example, Wi-Fi® access points and cellular base stations, but the examples are not limited to any particular type of wireless station.

At the point in time illustrated in FIG. 1, a plurality of mobile devices 26 may be connected to the AP 24, and via the AP 24 to other devices, such as, by way of non-limiting example, devices on the Internet. The mobile devices 26 may be connected to the AP 24 for any period of time, including a brief period such as a few minutes or an extended period, such as a few hours, a few days, or even longer. The term “connected” as used herein refers to the determination by the AP 24 that a mobile device 26 is authorized to communicate with the AP 24 and the AP 24 will provide service to the mobile device 26. With respect to a Wi-Fi wireless station, connection may be complete, for example, when the mobile device 26 successfully authenticates to the AP 24, or when the mobile device 26 obtains an IP address via the AP 24.

The mobile devices 26 include agent software that records certain information periodically and/or in response to some event. In some implementations, the AP 24 may be operated by an Internet service provider, and the mobile devices 26 may be associated with subscribers of the Internet service provider. The mobile devices 26 may have been provisioned with, or caused to download, the agent software.

The computing device 14 includes, or is communicatively coupled to, a storage device 28. The storage device 28 maintains mobile device connection information (MD CONN INFO) 30 that is obtained from the mobile devices 26 via the agent software executing on the mobile devices 26. The mobile device connection information 30 comprises a plurality of records 32-1-32-N (generally, records 32). The records 32 may be generated by the mobile devices 26 periodically, upon request, and/or in response to some event. The mobile devices 26 may push the records 32 to the computing device 14 periodically, upon request from the computing device 14, and/or in response to some event.

As an example of information generated by the agent software on a mobile device 26 and which may be provided to the computing device 14, the record 32-1 includes a timestamp field 34-1 that contains a timestamp of the time the record 32-1 was created by the mobile device 26, an identifier field 34-2 that contains an identifier of the mobile device 26 such as a media access control (MAC) address or other unique identifier, and a location field 34-3 that contains a location of the mobile device 26 at the time the record 32-1 was generated, such as, in this example, a latitude and longitude of the mobile device 26. The record 32-1 may also include an SSID field 34-4 that identifies the SSID to which the mobile device 26 is connected (if any), a BSSID field 34-5 that identifies the wireless station to which the mobile device 26 is connected (if any), a data transfer field 34-6 in which a data transfer value may be stored that is indicative of a quantity of time for a data packet to travel from the corresponding mobile device 26 to the wireless station or a round-trip time for a data packet to travel from the corresponding mobile device 26 to the wireless station, and an event field 34-7 which identifies an event, if any, that caused the generation of the record 32-1. In this example the data transfer field 34-6 contains the round trip latency time of a data packet communicated from the mobile device 26 to the wireless station to which the mobile device is connected.

The mobile device connection information 30 may contain such information for any number of wireless stations, and any number of mobile devices 26, and for any period of time. The mobile device connection information 30 may comprise millions of records 32.

The storage device 28 may also include wireless station information 36. The wireless station information 36 may comprise a plurality of records 38-1-38-Y, each of which corresponds to a wireless station, such as the AP 24. The record 38-1 corresponds to the AP 24 and includes, for example, a BSSID field 40-1 that contains the BSSID of the AP 24, a location field 40-2 that identifies a purported location of the AP 24, and a broadcast range field 40-3 that identifies a broadcast range of the AP 24.

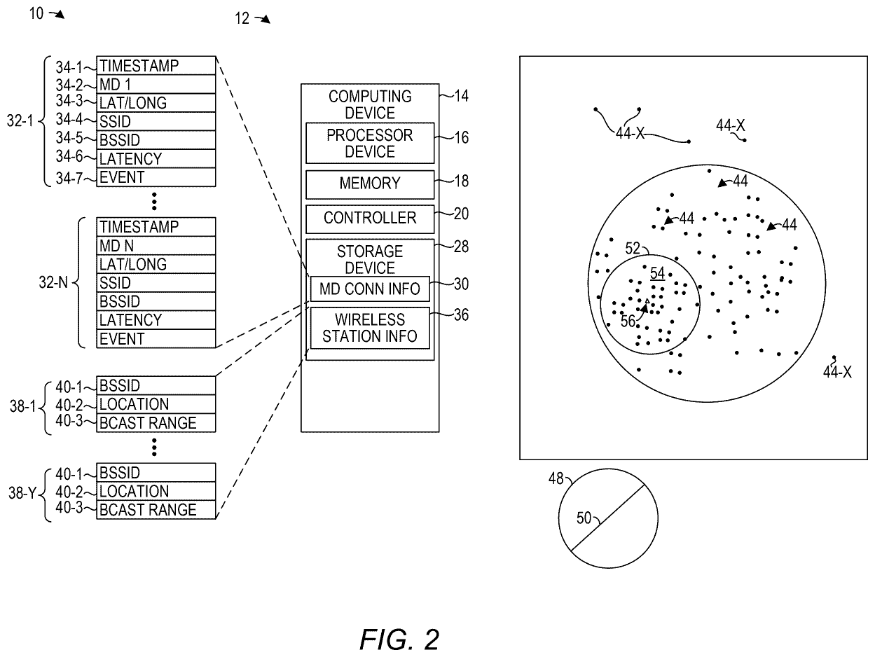

FIG. 2 is a block diagram of the environment 10 in conjunction with a diagram 42 for illustrating wireless station location identification according to one implementation. The controller 20 accesses the record 38-1, which corresponds to the AP 24 (not illustrated), and the records 32 to determine a location of the AP 24. The controller 20 may filter the records 32 such that the controller 20 selects only those records 32 wherein the BSSID identified in the BSSID field 34-5 matches the BSSID identified in the BSSID field 40-1 of the record 38-1. The diagram illustrates a plurality of mobile device locations 44, 44-1-44-4 (generally, mobile device locations 44) and mobile device locations 44-X, that are identified by the controller 20 based on the selected records 32. Each of the mobile device locations 44, 44-X corresponds to a different record 32, and identifies a location on the Earth that a corresponding mobile device 26 recorded as its location. In this example the locations are identified by longitude and latitude coordinates, but any suitable mechanism for identifying a location may be used. Some of the mobile device locations 44, 44-X may correspond to the same mobile device. The mobile device locations 44, 44-X may be referred to as a second plurality of mobile device locations 44, 44-X.

In practice, some agent software may incorrectly report being connected to a wireless station even after the mobile device 26 has disconnected from the AP 24. This may occur, for example, due to caching issues in the agent software, or other reasons. The controller 20 may preliminarily, for each selected record 32, access the data transfer field 34-6. The data transfer field 34-6 may contain a value of zero when a mobile device is not connected to a wireless station. Zero is an invalid value for a data transfer value because the quantity of time for a data packet to travel from the corresponding mobile device 26 to the AP 24 is greater than zero if the mobile device 26 is actually connected to the AP 24. Thus, even though the record 32 may indicate that the mobile device 26 is connected to the AP 24, a value of zero in the data transfer field 34-6 may indicate that the mobile device 26 is, in fact, not connected to the AP 24. In this example, each of the mobile device locations 44-X indicated a zero or an otherwise invalid value in the data transfer field 34-6. The controller 20 may then remove such mobile device locations 44-X from the second plurality of mobile device locations 44, 44-X to generate a first plurality of mobile device locations 44, as indicated by a circle 46 that encompasses all of the mobile device locations 44.

The controller 20 may then implement processing with respect to each mobile device location 44 which will be explained using a mobile device location 44-1. The controller 20 determines a size of a circle 48 based on a predetermined broadcast range that corresponds to the AP 24. The controller 20 may obtain the broadcast range from the broadcast range field 40-3 of the record 3-1. The controller 20 may use the value from the broadcast range field 40-3 to determine the size of the circle 48 or may multiply the value by some factor, such as 1.5 to determine the predetermined broadcast range. In this example, the circle 48 has a diameter 50 that is equal to the predetermined broadcast range.

The controller 20 identifies a determined location 52 of a circular area 54 having the size of the circle 48 that encompasses a greatest quantity of the first plurality of mobile device locations 44. Mechanisms for making this determination are discussed below. The controller 20 determines a location 56 of the AP 24 within the circular area 54. Based on the location 56 of the wireless station, the controller 20 may perform an action. For example, the controller 20 may compare the location 56 with the location of the AP 24 currently identified in the field 40-2 of the record 38-1. If the locations are greater than a predetermined distance apart, such as, by way of non-limiting example, 10 feet, 50 feet, 100 feet or any other suitable distance, the controller 20 may send an alert to a destination indicating that the location of the AP 24 currently identified in the field 40-2 of the record 38-1 is incorrect, and may include in the message the location 56 as the actual location. Alternatively, the controller 20 may replace the location of the AP 24 currently identified in the field 40-2 of the record 38-1 with the location 56.

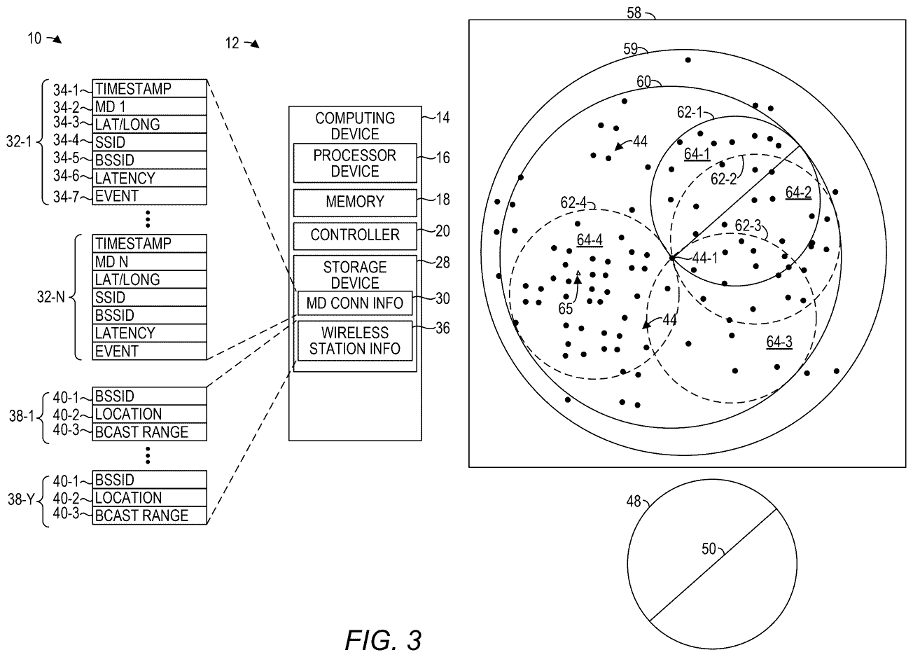

FIG. 3 is a block diagram of the environment 10 in conjunction with a diagram 58 for illustrating the identification of a determined location of a circular area that encompasses a greatest quantity of the mobile device locations according to one implementation. The controller 20 implements processing for each of the mobile device locations 44. Such processing will be described herein with respect to a particular mobile device location 44-1 and it should be noted that similar processing is implemented with respect to each of the other mobile device locations 44.

A circle 59 encompasses all possible mobile device locations 44 (after the mobile device locations 44-X have been trimmed). The controller 20 selects an initial mobile device location 44, in this example the mobile device location 44-1. The controller 20 determines a set of mobile device locations 44 that are within a predetermined distance of the mobile device location 44-1. In this example, the predetermined distance is the predetermined broadcast range of the AP 24 (FIG. 1) visually illustrated by the diameter 50 of the circle 38. In this example, the set of mobile device locations 44 that are within the predetermined distance of the mobile device location 44-1 are illustrated as being encompassed within a circle 60.

As will be discussed in greater detail below, in one implementation the controller 20 determines the distance between the mobile device location 44-1 and each other mobile device location by determining a distance from the mobile device location 44-1 to another mobile device location 44 along a great circle that encircles the Earth and on which the mobile device location 44-1 and the other mobile device location 44 lie is less than or equal to 2*r, wherein r=the radius of the circle 48, which in this example would be equal to the diameter 50. An advantage of determining the distance based on the length of a segment of a circle that encompasses the Earth is that the curvature of the Earth is taken into consideration when determining the distance between mobile device locations 44.

The controller 20 identifies a location 62-1 of a circular area 64-1 that has a size of the circle 48, wherein the mobile device location 44-1 is on a perimeter of the circular area 64-1. The controller 20 determines the number (e.g., quantity or count) of mobile device locations 44 within the circular area 64-1 and maintains the count and the location in a data structure. The controller 20 identifies another location 62-2 of a circular area 64-2 that has the size of the circle 48, wherein the mobile device location 44-1 is on the perimeter of the circular area 64-2. The controller 20 determines the number of mobile device locations 44 within the circular area 64-2 and maintains the count and the location in the data structure. The controller 20 repeats this process and determines a candidate circular area to be at the location of the circular area that has the greatest quantity of mobile device locations 44 within the circle 60. While for purposes of illustration the only four circles 64-1-64-4 are illustrated, in practice, the controller 20 may determine tens or hundreds of circles 64 by slowly incrementally sweeping the circles 64 360 degrees about the mobile device location 44-1 as a pivot point.

The controller 20 may implement the same process for each mobile device location 44 and for each such mobile device location identify a candidate location of a circular area containing the greatest quantity of mobile device locations. The controller 20 may then select the candidate location wherein the corresponding circular area encompasses the greatest quantity of mobile device locations 44 as the circular area within which the access point 24 is located. For purposes of illustration, assume that the location 62-4 of the circular area 64-4 is determined to encompass the greatest quantity of mobile device locations 44. The controller 20 may then select a mechanism for determining a location 65 within the location 62-4 of the AP 24. In one implementation, the AP 24 may simply select a location of the center of the circular area 64-4. In other implementations the controller 20 may utilize a location function that is based on the locations of the mobile device locations 44 within the circular area 64-4. For example, the controller 20 may utilize a Frechét mean function to determine the location 65 of the AP 24.

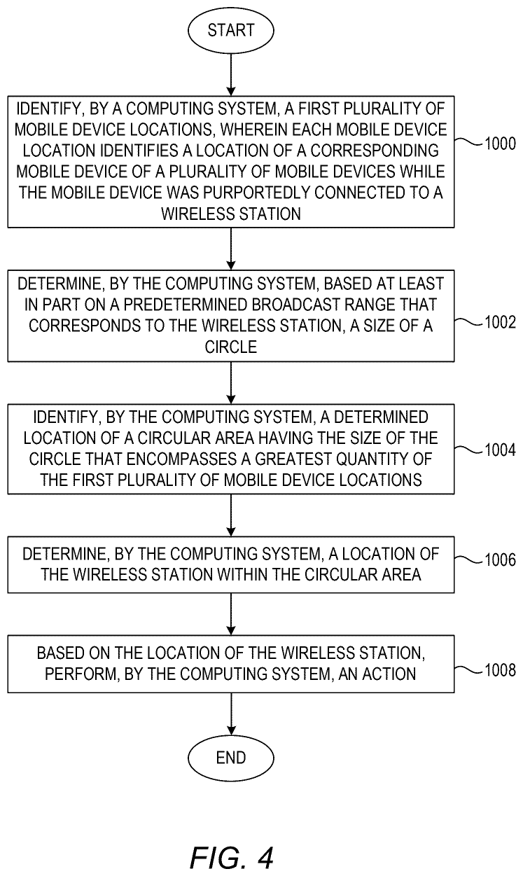

FIG. 4 is a flowchart of a method for wireless station location identification can according to one implementation. FIG. 4 will be discussed in conjunction with FIGS. 1 and 3. The computing device 14 identifies the first plurality of mobile device locations 44, wherein each mobile device location 44 identifies a location of a corresponding mobile device 26 of the plurality of mobile devices 26 while the mobile device 26 was purportedly connected to a wireless station, such as the AP 24 (FIG. 4 block 1000). The computing device 14 determines 32, based at least in part on a predetermined broadcast range that corresponds to the wireless station, the size of the circle 48 (FIG. 4 block 1002). The computing device 14 identifies the determined location 62-4 of the circular area 64-4 having the size of the circle 48 that encompasses a greatest quantity of the first plurality of mobile device locations 44 (FIG. 4 block 1004). The computing device 14 determines the location 65 of the wireless station 24 within the circular area 64-4 (FIG. 4 block 1006). The computing device 14, based on the location of the wireless station 24, performs an action (FIG. 4 block 1008).

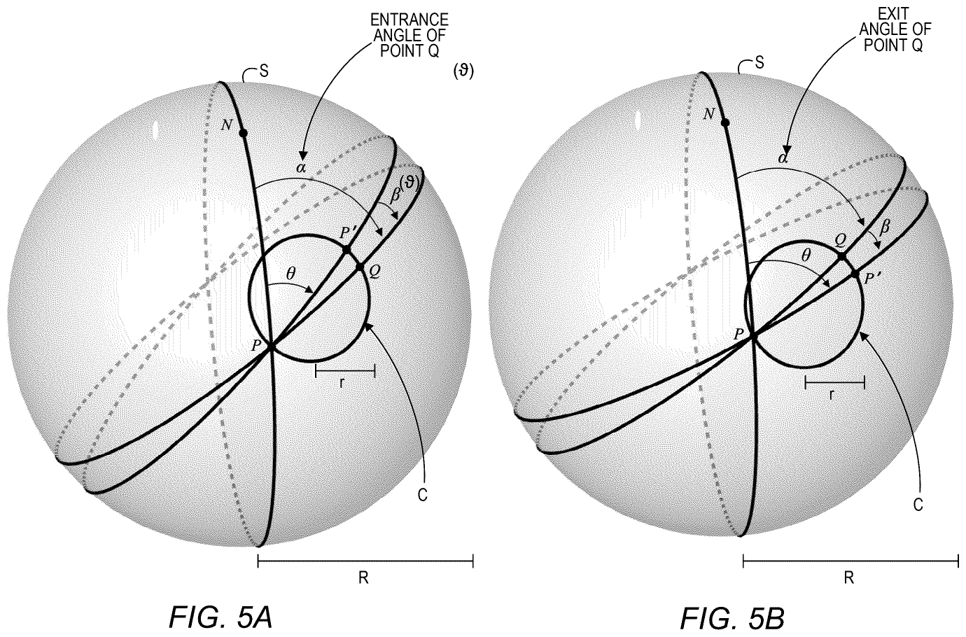

FIGS. 5A and 5B are diagrams that will be used to illustrate a mechanism for identifying a determined location of a circular area having the size of the circle that encompasses a greatest quantity of the plurality of mobile device locations 44 according to one implementation. In particular, FIG. 5A illustrates identifying an entrance angle of a point Q (representing, for example, a mobile device location 44) as a circle C is pivoted 360 degrees about a point P (representing a different mobile device location 44). The entrance angle identifies the location where Q enters the circle C. FIG. 5B illustrates identifying an exit angle of the point Q as the circle C continued to pivot 360 degrees about the point P. The exit angle identifies the location where Q exits the circle C.

The term “great circle” as used herein refers to a circle that results from cutting a sphere (such as the Earth) with a plane that passes through the origin of the sphere, and great circles are lines in spherical geometry. The result of cutting the sphere with a plane that does not contain the sphere's origin is referred to herein as a “small circle”. As will be discussed herein, a small circle C containing the largest number of mobile device locations 44 will be determined to be a circular area in which the wireless station is located. Initially a reference point that can be used to rotate a small circle on the sphere is determined. Absolute bearing angles may be used according to one implementation. Given two locations A and B, construct a great circle AN and a great circle AB, where N represents the north pole. The absolute bearing angle from A to B is the angle between the great circles AN and AB, which is the angle between the planes used to construct the great circles AN and AB.

Theorem 1. Referring to FIG. 5A, let P and Q be points on a sphere S of radius R. Consider a (not necessarily) small circle C of radius r≤πR on S that contains the distinct points P and Q, each of which represents a mobile device location 44. Let P′ denote the antipodal point of P on C, so that the great-circle distance between P and P′ (i.e., the distance along the great circle PP′ from P to P′) is 2r. If D is the great-circle distance between P and Q, then the angle ϑ between the great circles PP′ and PQ is given by

$$cos ( ϑ ) = \frac{tan ( \frac{D}{2 R} )}{tan ( r / R )} .$$

Proof. Let ρ denote the Euclidean distance between P and P′. It is straightforward to see that (1) ρ=R sin(r/R).

Note that the circle C is the intersection of S and a plane Π. If D=2r, then Q=P′ and the result is clear. Now assume that D<2r. In this event, there are two such possibilities for Π. Indeed, the small circles of radius r centered about P and Q will intersect in two places. Those intersection points determine the centers of the two small circles of radius r that contain both P and Q. Note that choosing one or the other results in a symmetric situation. Without loss of generality, we may choose our coordinate system so that Π is the plane z=R cos(r/R) and that the vector [symbol] is parallel to the x-axis, with midpoint lying on the z-axis.

Let β denote the angle between the vectors [symbol] and [symbol] and let d=| [symbol] |. Write Q=(Qx, Qy, Qz); recall that Qz=R cos(r/R), by the above assumption. Since cos(β)=d/(2φ=Q_{y}/\sqrt{4ρ²−d²}, we see that:

$${Q}_{x} = \frac{{d}^{2} - 2 {ρ}^{2}}{2 ρ} and {Q}_{y} = \frac{d}{2 ρ} \sqrt{4 {ρ}^{2} - {d}^{2}}$$

Thus, we see that P, P′ and Q have the following coordinates:
P:(−ρ, 0, R cos(r/R))
P′:(ρ, 0, R cos(r/R))
Q:((d2−2ρ2)/(2φ, d*SQRT(4ρ2−d2)/(2ρ), R cos(r/R))

Note that [symbol] := [symbol] 0, 1,0 [symbol] is a normal vector for the plane containing the great circle PP′. From the above coordinates, it is clear that the vector [symbol] defined by

$$\begin{matrix}\vec{{n}_{Q}} = \begin{matrix}〈 - ρ , 0 , R cos ( r / R ) \times 〈 ( {d}^{2} - 2 \vert {ρ}^{2} ) / \\ ( 2 ρ ) , \sqrt{4 {ρ}^{2} - {d}^{2}} / ( 2 ρ ) , R cos ( r / R ) 〉\end{matrix} \\ = - \frac{d}{2 ρ} 〈 R cos ( r / R ) \sqrt{4 {ρ}^{2} - {d}^{2}} , - dR cos ( r / R ) , ρ \sqrt{4 {ρ}^{2} - {d}^{2}}\end{matrix}$$

is a normal vector for the plane containing the great circle PQ. Since the angle between great circles coincides with the angle between the planes containing them, we deduce that

$$cos ( ϑ ) = \frac{\vec{{n}_{{P}^{′}}} \cdot \vec{{n}_{Q}}}{\vert \vec{{n}_{Q}} \vert} = \frac{dR cos ( r / R )}{ρ \sqrt{\vert 4 {{R}^{2} [ cos ( r / R ) ]}^{2} + 4 {ρ}^{2} - {d}^{2}}} .$$

From Equation (1) and the fact that d=2R sin(D/2R), we see that

$$cos ( ϑ ) = \frac{d cos ( r / R )}{2 R sin ( r / R ) cos ( \frac{D}{2 R} )} = \frac{tan ( \frac{D}{2 R} )}{tan ( r / R )}$$

as desired.

Assume that the location of the small circle C is rotated 360 degrees about the point P. From this result, it is straightforward to determine an entrance bearing angle that identifies a location that the point Q enters the small circle C (FIG. 5A) and an exit bearing angle that identifies a location that the point Q leaves the small circle C as the small circle C is rotated (FIG. 5B).

Theorem 2. Assume that the Earth is spherical of radius R, and let P be a point on the Earth. Let 0≤r≤πR. For each angle ϑ∈[0, 2π), consider the small circle C (ϑ) containing P and such that the bearing angle in radians from P to P′ is ϑ. Let Q be any point on the Earth with great-circle distance at most 2r. Let d denote great-circle distance between P and Q, and write β=arccos(tan(d/2R)/tan(r/R)). Let α denote the bearing angle in radians from P to Q. Then Q lies inside C (ϑ) for 0≤ϑ<2π if and only if α−β≤ϑ≤α+β.

Proof. If Q lies on the boundary of C (ϑ) and Q∈/C (φ) for 0≤φ<ϑ, then Q must lie below the diameter from P to P′, and so the bearing angle from P to P′ must be less or equal to the bearing angle from P to Q. Also note that each of the great circles NP, PP′ and PQ, where N is the north pole, contain both the origin O (i.e. center of the Earth) and P. In particular, the normal vector to each is perpendicular to OP and hence they are coplanar. In particular, the bearing angle from P to Q is the sum of the bearing angles from P to P′ and the angle between PQ and PP′. The result of Theorem 1 shows that ϑ=α−β. A similar argument shows the upper bound holds.

Thus, for any two points L₁ and L₂ on the spherical Earth, let h(L₁, L₂) denote the Haversine (geodesic) distance between L₁ and L₂, which is the length of the segment of the great circle determined by L₁ and L₂ that lies between them. Fix a point P on the spherical Earth. Let C_{P} (ϑ) denote the circle of radius r with P on its boundary and for which the absolute bearing angle from P to P′ is ϑ where P′=P′ (ϑ) denotes the diametrically opposite point of P on C (ϑ). For each point Q satisfying 0<h(P, Q)≤2r, define the angles μ_{P,Q}, η_{P,Q} to be the minimum angles satisfying the following two properties:
(i) O≤μ_{P,Q}≤η_{P,Q}<21;
(ii) Q∈C_{P} (ϑ) for 0≤ϑ<2 if and only if μ_{P,Q}<<η_{P,Q}.

We shall call pp, Q the entrance angle of Q with respect to P and η_{P,Q} the exit angle of Q with respect to P. Note that we know μ_{P,Q}=α_{P,Q}−β_{P,Q} and η_{P,Q}=α_{P,Q}+β_{P,Q} by Theorem 2.

Sort the elements of the set
A_{P}=(Q, μ_{Q}, −1):Q∈
(Q, n_{Q}, 1):Q∈S, 0<
using the rule
(Q₁, φ₁, b₁)≤(Q₂, φ₂, b₂) if and only if φ₁≤φ₂ and b₁<b₂.

Label the corresponding sequence {a₁, a₂, . . . , aₘ}. Let ρᵢ denote the projection of a point in A_{P} to its i^{th} component. Then the maximum number of points M_{P} inside a circle C_{P} (ϑ), ϑ∈[0, 2π), is given by

$${M}_{p} = max \{ {\sum }_{i = 1}^{j} {ρ}_{3} ( {a}_{i} ) : 1 \leq j \leq m \}$$

Thus, if one finds the point P∈S for which the sum M_{P} is maximal and the angle Q corresponding to the value in A_{P} for which this maximal sum is achieved, the circle can be constructed.

Referring again to FIG. 3, the entrance and exit bearing angles can be determined in accordance with the processing described above to identify entrance and exit bearing angle for each mobile device location 44 encompassed by the circle 60. The entrance and exit bearing angles can then be sorted based on the angle to form a sorted list. The sorted list can be traversed and a counter maintained as the list is traversed. The counter is incremented each time an entrance angle is encountered and decremented each time an exit angle is encountered. The angle at the location of the counter's maximum value identifies the location of the circular area containing the greatest number of mobile device locations 44.

In some implementations, to account for potential lack of rotational symmetry and uniform distribution of mobile device locations 44, the examples utilize a spherical Frechét mean. Using the spherical Frechét mean moves the estimated wireless station location towards the highest density area within the circular area. To implement the spherical Frechét mean, note that the mean of a set of elements in real Euclidean space X is the element that minimizes the function

$$μ ( c ) = {\sum }_{x ∈ X} {\vert x - c \vert}^{2} .$$

This is an example of a Frechét mean. In general, a Frechét mean of a set X with respect to a metric d is a minimizer of the function

$$c ↦ {\sum }_{x ∈ X} {d ( x , c )}^{p}$$

for some value of p. In real Euclidean space, it is quite easy to show that the Frechét mean for the Euclidean distance and p=2 (the usual mean) is given by the coordinate-wise average. In the case of the sphere with the great-circle (Haversine) distance, no closed form is known for any value of p. However, it can be iteratively approximated as follows.
For ease of computation, assume the sphere S has unit radius.
Given two points x and y lying on S, the great-circle (Haversine) distance between them, which we denote by h(x, y), is given by h(x, y)=arccos(x·y), where x·y is the usual dot product.
Thus, to find the spherical Frechét mean of a set of values X⊂S we want to minimize the function

$${μ}_{p} ( c ) = {\sum }_{x ∈ X} {𝔥 ( x , c )}^{p} = {\sum }_{x ∈ X} {( arccros ( x \cdot c ) )}^{p}$$

for points c on S. In other words, we want to minimize μₚ(c) with the con straint c·c=1.
Using the method of Lagrange multipliers, we know that a minimizer satisfies the equation

∇_{c}(μₚ(c)=λ(c·c−1))=0.

To solve this, note that this amounts to solving

$${\sum }_{x ∈ X} \frac{{p ( arccros ( x \cdot c ) )}^{p - 1} x}{\sqrt{1 - {( x \cdot c )}^{2}}} = 2 λ c .$$

### Write

$${g}_{p} ( c ) = {\sum }_{x ∈ X} \frac{{( arccros ( x \cdot c ) )}^{p - 1} x}{\sqrt{1 - {( x \cdot c )}^{2}}}$$

Rewriting the above equation, we need find a solution to the equation

$${κ}_{p} {g}_{p} ( c ) = c , where {κ}_{p} = \frac{1}{\vert {g}_{p} ( c ) \vert} ;$$

i.e. κₚ is just a scaling factor that ensures c lies on the sphere S. In particular, we simply need to find a fixed point of the function C [symbol] κₚgₚ(c) on S. By Brouwer's Fixed Point Theorem, a solution necessarily exists (since S is convex and compact).

Find a fixed point. One method for finding such a fixed-point is by using fixed-point iteration: Choose an initial guess c⁽⁰⁾. Then each subsequent guess is given by c⁽ⁱ⁺¹⁾=κₚgₚ(c⁽ⁱ⁾), where κ^{p}=/gₚ(c⁽ⁱ⁾/⁻¹. This method is continued until it stabilizes within a desired threshold. If the function C [symbol] κₚgₚ(c) is a contraction, a solution can be necessarily found this way, since the sequence of guesses is Cauchy; however, it is quite difficult to show that is the case. In fact, it is not guaranteed in general (consider antipodal points). However, with points in such close proximity and a sufficiently good initial guess (we used the average of the locations in Cartesian coordinates projected back to the sphere), it is not unreasonable to assume this algorithm does in fact converge to a solution as long as the sequence of successive attempts stay below the stopping tolerance for multiple steps.

We use the above Frechét Mean algorithm with the spherical angular sweeps algorithm described in FIGS. 1-4 to return a spherical Frechét mean for p=2 of the set of points in a circle of radius equal to the suggested broadcast radius of the wireless station that contains the largest number of mobile device locations 44 events to estimate the location of wireless station.

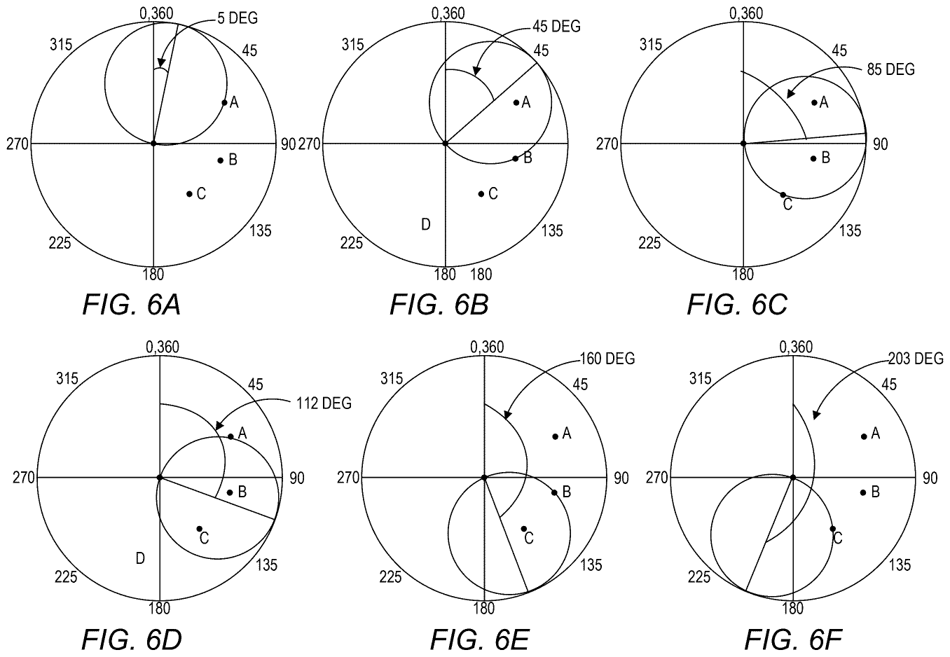

FIGS. 6A-6F are diagrams that visually illustrate the results of the processing discussed above with regard to FIGS. 5A and 5B via a circular area rotating about a particular mobile device location E with respect to three mobile device locations A, B, and C. Table 1 identifies example entrance and exit bearing angles for the mobile device locations A, B, and C that have been determined in accordance with the processing described above.

TABLE 1

| MOBILE DEVICE | | |
|---|---|---|
| LOCATION | ENTRANCE ANGLE | EXIT ANGLE |
| A | 5 | 112 |
| B | 45 | 160 |
| C | 85 | 203 |

Table 2 illustrates the angles being sorted into a list and keeping track of which value is an entrance angle (denoted by “I”) and an exit angle (denoted by “O”), as well as the value of a counter that is incremented for each entrance angle and decremented for each exit angle as the list is processed in order.

TABLE 2

| ANGLE | COUNTER |
|---|---|
| 5(I) | 1 |
| 45(1) | 2 |
| 85(1) | 3 |
| 112(O) | 2 |
| 160(O) | 1 |
| 203(O) | 0 |

In this example, the counter was at a maximum value of 3 at the angle 85 degrees. The controller 20 may determine that the location of the wireless station 24 is within the circular area illustrated in FIG. 6C. It is noted that, in practice, these calculations may involve hundreds or even thousands of mobile device locations 44, and this process may be performed for each such mobile device location 44. For example, in this example, the same process would be performed for each of the mobile device locations A, B and C, as pivot point locations.

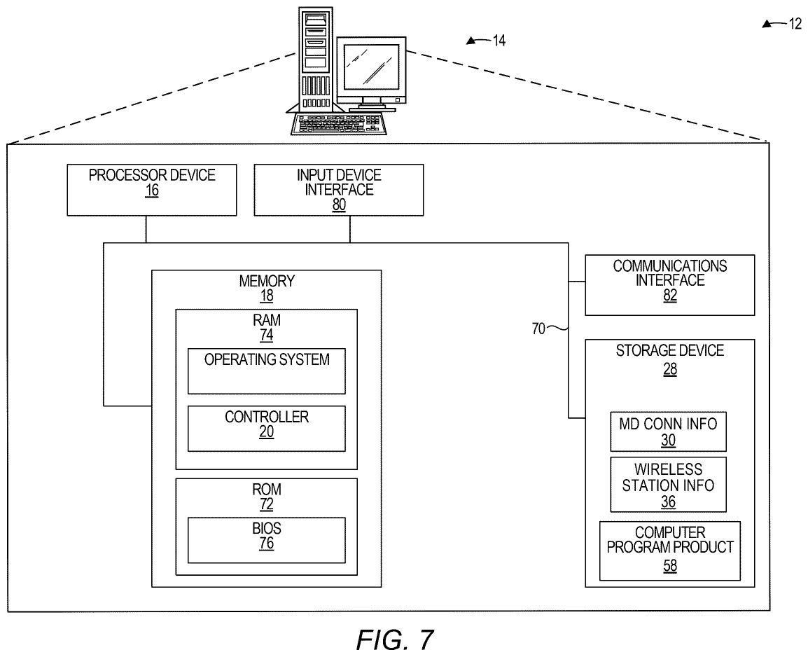

FIG. 7 is a block diagram of the computing system 12 according to one example. The computing system 12 includes one or more computing devices 14. The computing device 14 may comprise any computing or electronic device capable of including firmware, hardware, and/or executing software instructions to implement the functionality described herein, such as a computer server, a desktop computing device, or the like. The computing device 14 includes the processor device 16, the system memory 18, and a system bus 70. The system bus 70 provides an interface for system components including, but not limited to, the system memory 18 and the processor device 16. The processor device 16 can be any commercially available or proprietary processor.

The system bus 70 may be any of several types of bus structures that may further interconnect to a memory bus (with or without a memory controller), a peripheral bus, and/or a local bus using any of a variety of commercially available bus architectures. The system memory 18 may include non-volatile memory 72 (e.g., read-only memory (ROM), erasable programmable read-only memory (EPROM), electrically erasable programmable read-only memory (EEPROM), etc.), and volatile memory 74 (e.g., random-access memory (RAM)). A basic input/output system (BIOS) 76 may be stored in the non-volatile memory 72 and can include the basic routines that help to transfer information between elements within the computing device 14. The volatile memory 74 may also include a high-speed RAM, such as static RAM, for caching data.

The computing device 14 may further include or be coupled to a non-transitory computer-readable storage medium such as the storage device 28, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 28 and other drives associated with computer-readable media and computer-usable media may provide non-volatile storage of data, data structures, computer-executable instructions, and the like.

A number of modules can be stored in the storage device 28 and in the volatile memory 74, including an operating system and one or more program modules, such as the controller 20, which may implement the functionality described herein in whole or in part. All or a portion of the examples may be implemented as a computer program product 78 stored on a transitory or non-transitory computer-usable or computer-readable storage medium, such as the storage device 28, which includes complex programming instructions, such as complex computer-readable program code, to cause the processor device 16 to carry out the steps described herein. Thus, the computer-readable program code can comprise software instructions for implementing the functionality of the examples described herein when executed on the processor device 16. The processor device 16, in conjunction with the controller 20 in the volatile memory 74, may serve as a controller, or control system, for the computing device 14 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 16 through an input device interface 80 that is coupled to the system bus 70 but can be connected by other interfaces such as a parallel port, an Institute of Electrical and Electronic Engineers (IEEE) 1394 serial port, a Universal Serial Bus (USB) port, an IR interface, and the like. The computing device 14 may also include the communications interface 82, such as an Ethernet transceiver and/or a Wi-Fi transceiver, or the like, suitable for communicating with a network as appropriate or desired.

Individuals will recognize improvements and modifications to the preferred examples of the disclosure. All such improvements and modifications are considered within the scope of the concepts disclosed herein and the claims that follow.

What is claimed is:

1. A method comprising:
identifying, by a computing device, a first plurality of mobile device locations, wherein each mobile device location identifies a location of a corresponding mobile device of a plurality of mobile devices while the mobile device was purportedly connected to a wireless station;
determining, by the computing device, based at least in part on a predetermined broadcast range that corresponds to the wireless station, a size of a circle;
identifying, by the computing device, a determined location of a circular area having the size of the circle that encompasses a greatest quantity of mobile device location of the first plurality of mobile device locations;
determining, by the computing device, a location of the wireless station within the circular area; and
based on the location of the wireless station, performing, by the computing device, an action.

2. The method of claim 1, further comprising:
prior to identifying the first plurality of mobile device locations, identifying, by the computing device, a second plurality of mobile device locations and a plurality of corresponding data transfer values, each mobile device location of the second plurality of mobile device locations identifying a location of a corresponding mobile device of the plurality of mobile devices while the mobile device was purportedly connected to the wireless station, each corresponding data transfer value being based at least in part on a quantity of time for a data packet to travel from the corresponding mobile device to the wireless station; and
removing, by the computing device, each mobile device location of the second plurality of mobile device locations from the second plurality of mobile device locations wherein the corresponding data transfer value has an invalid value to generate the first plurality of mobile device locations.

3. The method of claim 1, wherein identifying the determined location of the circular area having the size of the circle that encompasses the greatest quantity of the first plurality of mobile device locations further comprises:
identifying a plurality of candidate locations of corresponding ones of a plurality of candidate circular areas, by:
for each respective mobile device location of the plurality of mobile device locations:
determining a set of mobile device locations of the plurality of mobile device locations, wherein the set of mobile device locations comprises all mobile device locations of the plurality of mobile device locations that are within a predetermined distance of the respective mobile device location, the predetermined distance being a diameter of the size of the circle;
identifying a plurality of locations of corresponding ones of a plurality of circular areas having the size of the circle, wherein the respective mobile device location is on a perimeter of each circular area of the plurality of circular areas; and
determining a candidate location of a candidate circular area to be a location of the plurality of locations wherein the corresponding circular area has a greater quantity of mobile device locations than any other circular area; and
identifying the determined location of the circular area to be the candidate location of the candidate circular area of the plurality of locations of corresponding ones of the plurality of circular areas that encompasses a greatest quantity of the mobile device locations.

4. The method of claim 3, wherein determining the set of mobile device locations of the first plurality of mobile device locations for at least one respective mobile device location of the plurality of mobile device locations further comprises:
for each mobile device location in the set of mobile device locations:
determining that a distance between the at least one respective mobile device location and the mobile device location in the set of mobile device locations along a great circle that encircles the Earth and on which the at least one respective mobile device location and the mobile device location in the set of mobile device locations lie is less than or equal to 2*r, wherein r=a radius of the size of the circle.

5. The method of claim 1, wherein identifying the determined location of the circular area having the size of the circle that encompasses the greatest quantity of the first plurality of mobile device locations further comprises:
identifying a plurality of candidate locations by, for each respective mobile device location of the first plurality of mobile device locations:
determining a set of mobile device locations of the first plurality of mobile device locations, wherein the set of mobile device locations comprises all mobile device locations of the first plurality of mobile device locations that are within a predetermined distance of the respective mobile device location, the predetermined distance being a diameter of the size of the circle;
using the respective mobile device location as a pivot point, sweeping a circle having the size of the circle 360 degrees about the pivot point;
determining, as the circle sweeps about the pivot point, a candidate location of the circle that encompasses a greatest quantity of mobile devices in the set of mobile devices; and
selecting, as the determined location, the candidate location of the plurality of candidate locations wherein the corresponding circle encompasses the greatest quantity of mobile device locations.

6. The method of claim 1, wherein determining the location of the wireless station within the circular area comprises:
determining a center of a largest cluster of the mobile device locations encompassed by the circular area located at the determined location; and
determining that the location of the wireless station within the circular area is the center of the largest cluster.

7. The method of claim 1, wherein determining the location of the wireless station within the circular area comprises:
determining, based on a Frechét mean of the mobile device locations encompassed by the circular area located at the determined location, a Frechét mean location; and
determining that the Frechét mean location is the location of the wireless station within the circular area.

8. The method of claim 1, wherein the wireless station comprises a Wi-Fi access point or a cellular transceiver.

9. The method of claim 1, wherein performing the action comprises:
comparing the location of the wireless station with a purported location of the wireless station;
determining that a distance between the location of the wireless station and the purported location is greater than a predetermined distance; and
in response to determining that the distance between the location of the wireless station and the purported location is greater than the predetermined distance, replacing the purported location with the location or sending an alert to a destination indicating that the purported location is an incorrect location.

10. A computing device, comprising:
a memory; and
a processor device coupled to the memory operable to:
identify a first plurality of mobile device locations, wherein each mobile device location identifies a location of a corresponding mobile device of a plurality of mobile devices while the mobile device was purportedly connected to a wireless station;
determine, based at least in part on a predetermined broadcast range that corresponds to the wireless station, a size of a circle;
identify a determined location of a circular area having the size of the circle that encompasses a greatest quantity of mobile device location of the first plurality of mobile device locations;
determine a location of the wireless station within the circular area; and
based on the location of the wireless station, perform an action.

11. The computing device of claim 10, wherein to identify the determined location of the circular area having the size of the circle that encompasses the greatest quantity of the first plurality of mobile device locations, the processor device is further operable to:
identify a plurality of candidate locations of corresponding ones of a plurality of candidate circular areas, by:
for each respective mobile device location of the plurality of mobile device locations:
determine a set of mobile device locations of the plurality of mobile device locations, wherein the set of mobile device locations comprises all mobile device locations of the plurality of mobile device locations that are within a predetermined distance of the respective mobile device location, the predetermined distance being a diameter of the size of the circle;
identify a plurality of locations of corresponding ones of a plurality of circular areas having the size of the circle, wherein the respective mobile device location is on a perimeter of each circular area of the plurality of circular areas; and
determine a candidate location of a candidate circular area to be a location of the plurality of locations wherein the corresponding circular area has a greater quantity of mobile device locations than any other circular area; and
identify the determined location of the circular area to be the candidate location of the candidate circular area of the plurality of locations of corresponding ones of the plurality of circular areas that encompasses a greatest quantity of the mobile device locations.

12. The computing device of claim 10, wherein to identify the determined location of the circular area having the size of the circle that encompasses the greatest quantity of the first plurality of mobile device locations, the processor device is further operable to:
identify a plurality of candidate locations by, for each respective mobile device location of the first plurality of mobile device locations:
determine a set of mobile device locations of the first plurality of mobile device locations, wherein the set of mobile device locations comprises all mobile device locations of the first plurality of mobile device locations that are within a predetermined distance of the respective mobile device location, the predetermined distance being a diameter of the size of the circle;
using the respective mobile device location as a pivot point, sweep a circle having the size of the circle 360 degrees about the pivot point;
determine, as the circle sweeps about the pivot point, a candidate location of the circle that encompasses a greatest quantity of mobile devices in the set of mobile devices; and
select, as the determined location, the candidate location of the plurality of candidate locations wherein the corresponding circle encompasses the greatest quantity of mobile device locations.

13. The computing device of claim 10, wherein to determine the location of the wireless station within the circular area, the processor device is further operable to:
determine, based on a Frechét mean of the mobile device locations encompassed by the circular area located at the determined location, a Frechét mean location; and
determine that the Frechét mean location is the location of the wireless station within the circular area.

14. The computing device of claim 10, wherein to perform the action the processor device is further operable to:
compare the location of the wireless station with a purported location of the wireless station;
determine that a distance between the location of the wireless station and the purported location is greater than a predetermined distance; and
in response to determining that the distance between the location of the wireless station and the purported location is greater than the predetermined distance, replace the purported location with the location or sending an alert to a destination indicating that the purported location is an incorrect location.

15. A non-transitory computer-readable storage medium that includes executable instructions operable to cause a processor device to:
identify a first plurality of mobile device locations, wherein each mobile device location identifies a location of a corresponding mobile device of a plurality of mobile devices while the mobile device was purportedly connected to a wireless station;
determine, based at least in part on a predetermined broadcast range that corresponds to the wireless station, a size of a circle;
identify a determined location of a circular area having the size of the circle that encompasses a greatest quantity of mobile device location of the first plurality of mobile device locations;
determine a location of the wireless station within the circular area; and
based on the location of the wireless station, perform an action.

16. The non-transitory computer-readable storage medium of claim 15, wherein to identify the determined location of the circular area having the size of the circle that encompasses the greatest quantity of the first plurality of mobile device locations, the processor device is further operable to:
identify a plurality of candidate locations of corresponding ones of a plurality of candidate circular areas, by:
for each respective mobile device location of the plurality of mobile device locations:
determine a set of mobile device locations of the plurality of mobile device locations, wherein the set of mobile device locations comprises all mobile device locations of the plurality of mobile device locations that are within a predetermined distance of the respective mobile device location, the predetermined distance being a diameter of the size of the circle;
identify a plurality of locations of corresponding ones of a plurality of circular areas having the size of the circle, wherein the respective mobile device location is on a perimeter of each circular area of the plurality of circular areas; and
determine a candidate location of a candidate circular area to be a location of the plurality of locations wherein the corresponding circular area has a greater quantity of mobile device locations than any other circular area; and
identify the determined location of the circular area to be the candidate location of the candidate circular area of the plurality of locations of corresponding ones of the plurality of circular areas that encompasses a greatest quantity of the mobile device locations.

17. The non-transitory computer-readable storage medium of claim 15, wherein to identify the determined location of the circular area having the size of the circle that encompasses the greatest quantity of the first plurality of mobile device locations, the processor device is further operable to:
identify a plurality of candidate locations by, for each respective mobile device location of the first plurality of mobile device locations:
determine a set of mobile device locations of the first plurality of mobile device locations, wherein the set of mobile device locations comprises all mobile device locations of the first plurality of mobile device locations that are within a predetermined distance of the respective mobile device location, the predetermined distance being a diameter of the size of the circle;
using the respective mobile device location as a pivot point, sweep a circle having the size of the circle 360 degrees about the pivot point;
determine, as the circle sweeps about the pivot point, a candidate location of the circle that encompasses a greatest quantity of mobile devices in the set of mobile devices; and
select, as the determined location, the candidate location of the plurality of candidate locations wherein the corresponding circle encompasses the greatest quantity of mobile device locations.

18. The non-transitory computer-readable storage medium of claim 15, wherein to determine the location of the wireless station within the circular area, the processor device is further operable to:
determine, based on a Frechét mean of the mobile device locations encompassed by the circular area located at the determined location, a Frechét mean location; and
determine that the Frechét mean location is the location of the wireless station within the circular area.

19. The non-transitory computer-readable storage medium of claim 15, wherein to perform the action the processor device is further operable to:
compare the location of the wireless station with a purported location of the wireless station;
determine that a distance between the location of the wireless station and the purported location is greater than a predetermined distance; and
in response to determining that the distance between the location of the wireless station and the purported location is greater than the predetermined distance, replace the purported location with the location or sending an alert to a destination indicating that the purported location is an incorrect location.

20. non-transitory computer-readable storage medium of claim 15, wherein the wireless station comprises a Wi-Fi access point or a cellular transceiver.
